(19) United States
(12) Patent Application Publication
(10) Pub. No.: US 2006/0176355 A1
(43) Pub. Date: Aug. 10, 2006

(54) Color registration apparatus and method in electrophotographic printer and computer-readable recording medium storing computer program

(75) Inventor: Seung-deog An, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/340,765

(22) Filed: Jan. 27, 2006

(30) Foreign Application Priority Data
Feb. 5, 2005 (KR) 2005-0011014

(51) Int. Cl. G03G 15/01

(52) U.S. Cl. 347/116; 399/301

(57) ABSTRACT

Provided are a color registration compensation apparatus and method in an electrophotographic printer and computer-readable recording medium storing a computer program. The apparatus includes an exposing unit that irradiates light onto a photoconductive drum which forms a first latent image, which is a mark a second latent image, having a predetermined shape, on an area surrounding the mark, and a third latent image . A developing unit develops the first through third latent images with a predetermined density according to color tones. A mark sensing unit senses toner images by irradiating predetermined light onto the surface of the transfer belt after developing the latent images, and by sensing irregularly reflected light of the irradiated light. A controller compares the intensity of the irregularly reflected light with a predetermined threshold and determines exposure starting times according to time information relating to a point of time of the latent image sensing.

### CROSS-REFERENCE TO RELATED PATENT APPLICATION

This application claims the benefit under 35 U.S.C. §119(a) of Korean Patent Application No. 10-2005-0011014, filed on Feb. 5, 2005, in the Korean Intellectual Property Office, the entire disclosure of which is hereby incorporated by reference.

### BACKGROUND OF THE INVENTION

1. Field of the Invention

The present invention relates to color registration compensation in an electrophotographic printer such as a laser printer. More particularly, the present invention relates to a color registration compensation apparatus, a method in an electrophotographic printer that determines a color registration compensation value without error, and a computer-readable recording medium storing a computer program of the color registration compensation.

2. Description of the Related Art

An electrophotographic printer such as a color laser printer generally includes four photoconductive drums, an exposing unit, a developing unit, and a transfer belt. The four photoconductive drums correspond to four colors such as yellow, cyan, magenta, and black. The exposing unit shines a light beam on each photoconductive drum, thereby forming an electrostatic latent image.

The developing unit develops the electrostatic latent image using developers for the colors. The images developed on the photoconductive drums are sequentially transferred to the transfer belt, thereby forming a full color image which is then transferred to paper.

To print a correct color image, the transfer starting and ending positions of toner images on the photoconductive drums must be matched. Therefore, to correctly recognize the color image, it is important to correctly synchronize an exposure starting time of the exposing unit for the photoconductive drums, while considering the speed of the transfer belt. Here, a correct setting of the exposure starting time is called color registration.

Although the exposure starting time is exactly set to an initial setting value, mis-registration may gradually occur after printing for a time duration. For example, if a driving roller diameter of the transfer belt is increased due to printing heat, the speed of the transfer belt can vary, even though the driving roller makes the same number of rotations. Thus, if the exposure begins at the exposure starting time set to the initial setting value, the color registration cannot be achieved. As a result, a method of dynamically controlling the exposure starting time is required. The practice of dynamically controlling the exposure starting time set to the initial setting value, to compensate for the mis-registration, in order to correctly print the desired color image, is called color registration compensation.

FIGS. 1A and 1B are reference diagrams of an example for illustrating an operational principle of a conventional color registration compensation apparatus. Referring to FIG. 1A, for the color registration compensation, a degree of mis-registration between marks for colors can be recognized by forming predetermined marks on photoconductive drums (not shown) using an exposing unit (not shown), developing the marks, transferring the developed marks to a transfer belt 120, and detecting the transferred marks using a sensor 110 for each color. In this manner, the exposure starting time of each color can be adjusted.

In more detail, the sensor 110 senses a toner image 130 of the developed mark by irradiating a predetermined light beam, an incidence light 114, on the surface of the transfer belt 120 and sensing a regularly reflected light beam 115. The regular reflection is a reflection in which the incidence angle 112 is equal to the reflection angle 113. Here, the toner image 130 may form a chromatic color, such as yellow, cyan, or magenta, or an achromatic color such as black.

If the toner image 130 is a chromatic color, most of the incidence light 114 is reflected, and if the toner image 130 is an achromatic color, most of the incidence light 114 is absorbed. According to a timing diagram of a sensing light intensity shown in FIG. 1B, most of the incidence light 114 irradiated on the surface of the transfer belt 120, on which the toner image 130 does not exist, is reflected. Moreover, the incidence light 114 irradiated on the toner image 130 is reflected at reduced intensity. Here, the sensing light intensity indicates the intensity of the reflected light beam 115 sensed by the sensor 110, and the incidence light 114, which has a light intensity value of V.

Referring to FIG. 1B, a light beam reflected on the toner image 130 of a black mark is sensed with lower sensing light intensity 140. Light beams reflected on the toner images 130 of cyan, magenta, and yellow marks are sensed with only slightly reduced sensed light intensities 142, 144, and 146. Sensed light intensities 148 and 149 can fluctuate due to defects on the surface of the transfer belt 120. In particular, the sensing light intensity such as the sensed light intensity 149 can be confused with the sensed light intensities 142, 144, and 146 reflected from the toner images 130 of chromatic marks. As a result, the conventional color registration compensation apparatus is easily influenced by defects on the surface of the transfer belt 120.

FIGS. 1C and 1D are reference diagrams of another example for illustrating the operational principle of the conventional color registration compensation apparatus. To solve the above-described problem, a scheme of sensing irregularly reflected light 117 was suggested as shown in FIG. 1C. Here, the sensor 110 does not sense regularly reflected light 115. The irregular reflection is a reflection in which the incidence angle 112 is not equal to the reflection angle 118. In this case, according to a timing diagram of the sensing light intensity shown in FIG. 1D, defects on the surface of the transfer belt 120 have little effect. However, the conventional color registration compensation apparatus cannot sense a light beam 150 reflected from the toner image 130 of the black mark.

Accordingly, there is a need for an improved color registration apparatus that correctly calculates a color registration compensation value.

### SUMMARY OF THE INVENTION

An aspect of embodiments of the present invention is to address at least the above problems and/or disadvantages and to provide at least the advantages described below. Accordingly, an aspect of embodiments of the present invention is to provide a color registration compensation apparatus in an electrophotographic printer that calculates a color registration compensation value without error, by correctly sensing marks by controlling color density developed for the mark areas.

Exemplary embodiments of the present invention also provides a color registration compensation method in an electrophotographic printer that calculates a color registration compensation value without error by correctly sensing marks by controlling color density developed for the mark areas.

Exemplary embodiments of the present invention also provides a computer-readable recording medium storing at least one computer program that calculates a color registration compensation value without error by correctly sensing marks by controlling color density developed for the mark areas.

According to an aspect of an exemplary embodiment of the present invention, there is provided a color registration compensation apparatus for adjusting exposure starting times on photoconductive drums for respective color units so that images developed with a plurality of color tones match each other on a transfer belt and are correctly superimposed in an electrophotographic printer. The apparatus includes an exposing unit which forms a first latent image, which is a latent image of a mark, by irradiating light onto the photoconductive drum corresponding to a chromatic color, forms a second latent image, having a predetermined shape, on an area surrounding a mark by irradiating light onto the photoconductive drum corresponding to an achromatic color, and forms a third latent image by irradiating light onto the photoconductive drum corresponding to a predetermined chromatic color. A developing unit develops the first, second, and third latent images with a predetermined density according to color tones corresponding to the photoconductive drums on which the latent images are formed. A mark sensing unit senses toner images by irradiating a predetermined light onto the surface of the transfer belt in which the toner images are transferred after developing the latent image, and by sensing irregularly reflected light of the irradiated light. A color registration controller compares a time-based value of sensing light intensity, which is intensity of the irregularly reflected light sensed for the mark area, with a predetermined threshold and determines the exposure starting times according to time information relating to a point of time of the latent image sensing in response to a comparison result, wherein the toner images are the developed latent images, and the toner image of the transferred third latent image exists in an area including a central area of the mark surrounding area within the toner image of the transferred second latent image.

The color registration controller may compare a maximum value of the sensing light intensity with a predetermined reference light intensity value, compare a sensing time, which is time required for sensing the mark area, with a predetermined reference time, and adjust the exposure starting times based on the time information.

The color registration controller may determine the exposure starting times based on the time information if the maximum value of the sensing light intensity is greater than a predetermined reference light intensity value and if a sensing time, which is time required for sensing the mark area, is less than a predetermined reference time.

The color registration controller may increase a predetermined density and command re-sensing if the maximum value of the sensing light intensity is less than a predetermined reference light intensity value.

The color registration controller may change a predetermined density and command re-sensing if a sensing time, which is time required for sensing each mark area, is greater than a predetermined reference time.

The developing unit, which receives the re-sensing command, may develop a reformed second latent image with a higher density than the predetermined density.

The developing unit, which receives the re-sensing command, may develop a reformed third latent image with a lower density than the predetermined density.

The color registration controller may include a compensation yes/no decision unit which determines whether a maximum value of the sensing light intensity is greater than a predetermined reference light intensity value, and whether a sensing time, which is the time required for sensing each mark area, is less than a predetermined reference time. A compensation value determiner determines the exposure starting time for a respective color units using sensed time information, if the maximum value of the sensing light intensity is greater than the predetermined reference light intensity value and if the sensing time is less than the predetermined reference time.

The color registration controller may further include a pulse generator which sets sensing light intensity values less than a previously determined value to 0 and sets sensing light intensity values exceeding the previously determined value to a predetermined value, if the maximum value of the sensing light intensity is greater than the predetermined reference light intensity value and if the sensing time is less than the predetermined reference time. The compensation value determiner may determine the exposure starting time for respective color units using the time information obtained by sensing the predetermined value, and the sensing light intensity value may be a value of the sensing light intensity.

The color registration controller may further include a density controller which commands the exposing unit, developing unit, and mark sensing unit to operate under circumstances that the predetermined density is changed, if the maximum value of the sensing light intensity is less than the reference light intensity value.

The color registration controller may further include a density controller which commands the exposing unit, developing unit, and mark sensing unit to operate under circumstances that the predetermined density is changed, if the sensing time is greater than the reference time. The threshold, the reference light intensity value, and the reference time may be variable.

According to another aspect of an exemplary embodiment of the present invention, there is provided a color registration compensation method of adjusting exposure starting times on photoconductive drums for respective color units so that images developed with a plurality of color tones match each other on a transfer belt and are correctly superimposed in an electrophotographic printer. The method includes a first latent image formed, which is a latent image of a mark, by irradiating light onto the photoconductive drum corresponding to a chromatic color, forming a second latent image, having a predetermined shape, on an area surrounding the mark by irradiating light onto the photoconductive drum corresponding to an achromatic color, and forming a third latent image by irradiating light onto the photoconductive drum corresponding to a predetermined chromatic color. The first, second and third latent images are developed with a predetermined density according to color tones corresponding to the photoconductive drums on which the latent images are formed. Toner images are sensed by irradiating predetermined light onto the surface of the transfer belt to which the toner images are transferred after the development, and by sensing irregularly reflected light of the irradiated light. A time-based value of sensing light intensity is compared, which is the intensity of the irregularly reflected light sensed for the mark area, with a predetermined threshold, and determining the exposure starting times according to time information relating to a point of time of latent image sensing in response to a comparison result, wherein the toner images are the developed latent images, and the toner image of the transferred third latent image exists in an area including a central area of the mark surrounding area within the toner image of the transferred second latent image.

According to another aspect of an exemplary embodiment of the present invention, there is provided a computer-readable recording medium storing a computer readable program for performing a color registration compensation method of adjusting exposure starting times on photoconductive drums for respective color units so that images developed with a plurality of color tones match each other on a transfer belt and are correctly superimposed in an electrophotographic printer. The method includes a first latent image formed, which is a latent image of a mark, by irradiating light onto the photoconductive drum corresponding to a chromatic color, forming a second latent image, having a predetermined shape, on an area surrounding the mark by irradiating light onto the photoconductive drum corresponding to an achromatic color, and forming a third latent image by irradiating light onto the photoconductive drum corresponding to a predetermined chromatic color. The first, second, and third latent images are developed with a predetermined density according to color tones corresponding to the photoconductive drums on which the latent images are formed. Toner images are sensed by irradiating a predetermined light onto the surface of the transfer belt in which the toner images are transferred after developing the latent image, and by sensing irregularly reflected light of the irradiated light. A time-based value of sensing light intensity is compared, which is the intensity of the irregularly reflected light sensed for the mark area, with a predetermined threshold, and determining the exposure starting times according to time information relating to a point of time of latent image sensing in response to a comparison result, wherein the toner images are the developed latent images, and the toner image of the transferred third latent image exists in an area including a central area of the mark surrounding area within the toner image of the transferred second latent image.

Other objects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIGS. 1A through 1D are reference diagrams for illustrating operational principles of a conventional color registration compensation apparatus;

FIG. 2 is a block diagram of a color registration compensation apparatus in an electrophotographic printer according to an exemplary embodiment of the present invention;

FIG. 3 is a perspective view of an exposing unit, a developing unit and a mark sensing unit shown in FIG. 2;

FIGS. 4A through 4E are reference diagrams for illustrating a toner image of a black mark transferred to the surface of a transfer belt;

FIGS. 5A and 5B are timing diagrams illustrating light intensity sensed by the color registration compensation apparatus in the electrophotographic printer according to an exemplary embodiment of the present invention;

FIG. 6 is a detailed block diagram of a color registration controller shown in FIG. 2;

FIGS. 7, 8A, 8B and 8C are timing diagrams for illustrating IN1 and IN2 shown in FIG. 6; and

FIG. 9 is a flowchart illustrating a color registration compensation method in an electrophotographic printer according to an exemplary embodiment of the present invention.

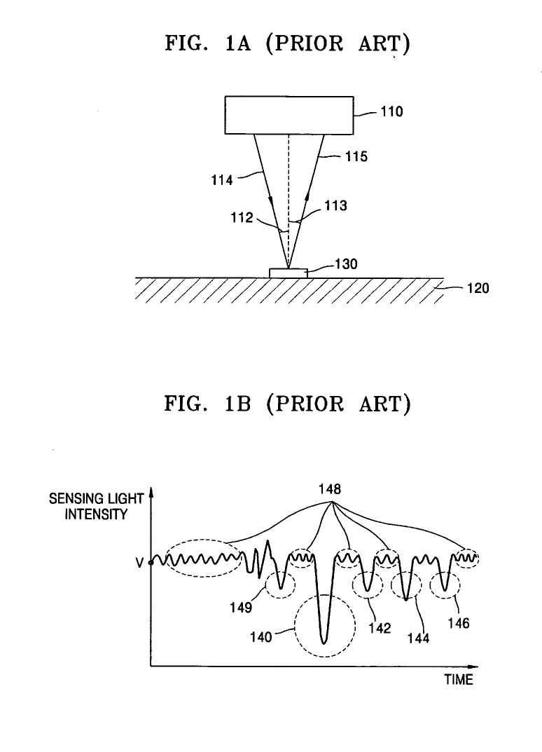

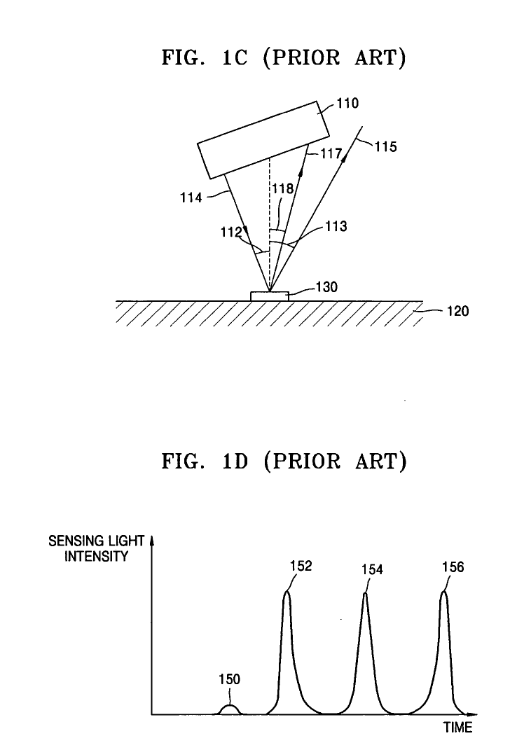

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

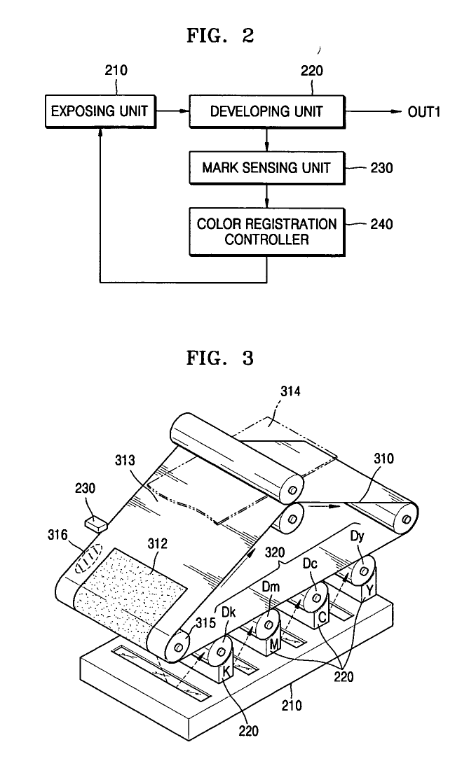

FIG. 2 is a block diagram of a color registration compensation apparatus in an electrophotographic printer according to an exemplary embodiment of the present invention. Referring to FIG. 2, the apparatus includes an exposing unit 210, a developing unit 220, a mark sensing unit 230, and a color registration controller 240.

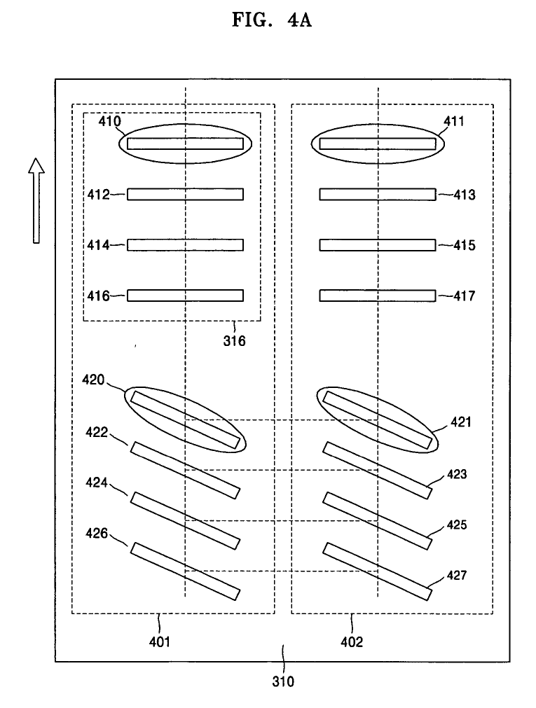

FIG. 3 is a perspective view of the exposing unit 210, the developing unit 220, and the mark sensing unit 230 shown in FIG. 2. Referring to FIG. 3, the exposing unit 210 forms a predetermined image on a photoconductive drum 320 for each color unit. The exposing unit 210 preferably irradiates light onto the rotating photoconductive drums 320. The exposing unit 210 preferably includes a plurality of exposing devices. Here, one exposing device exists for each color.

If the exposing unit 210 irradiates light on the photoconductive drum 320 to form an image, a latent image of the image is formed on the surface of the photoconductive drum 320. The latent image is called an electrostatic latent image (hereinafter, latent image).

Before irradiating light for forming target images on the photoconductive drums 320, the exposing unit 210 irradiates light for forming marks 316 for color registration. The target images are the image, which a user desires to print, and the marks 316 are predetermined identifiers.

The total color units used for the apparatus are preferably yellow (Y), cyan (C), magenta (M), and black (B). One photoconductive drum 320 exists for each color unit. The exposing unit 210 forms latent images of the target images on the surfaces of the photoconductive drums 320 by irradiating light on the photoconductive drums 320 with time differences for the respective color units. The exposing unit 210 irradiates light on each of the photoconductive drums 320 in the order of Dy, Dc, Dm, and Dk in FIG. 3. If the exposure begins, according to a correct color registration compensation value, toner images on the photoconductive drums 320 are exactly synchronized on the surface of the transfer belt 310 and are perfectly superimposed. Here, a toner image indicates a developed latent image. Hereinafter, a toner image of a target image indicates a developed target image, and a toner image of the mark 316 indicates a developed latent image of the mark 316.

To irradiate light for forming the marks 316, the exposing unit 210 may irradiate the light onto the photoconductive drums 320 with fixed or unfixed time differences for the respective color units.

The exposing unit 210 may irradiate the light onto the photoconductive drums 320 for the respective color units at the same time. Here, exposure starting positions of the surfaces of the photoconductive drums 320 are synchronized for all color units. Toner images of the marks 316 are transferred onto the surface of the transfer belt 310 in the order of K, M, C, and Y. That is, the toner images transferred onto the surface of the transfer belt 310 indicate a latent image developed with black, a latent image developed with magenta, a latent image developed with cyan, and a latent image developed with yellow, in that order.

Upon irradiating light for forming the marks 316, the exposing unit 210 forms a first latent image, which is a latent image of the mark 316, by irradiating the light onto the photoconductive drum 320 corresponding to a chromatic color.

Upon irradiating light for forming the marks 316, the exposing unit 210 forms a second latent image, which is a latent image of a predetermined shape, on the area surrounding the marks 316 by irradiating light onto the photoconductive drum 320 corresponding to an achromatic color. A third latent image is formed by irradiating the light onto the photoconductive drum 320 corresponding to a predetermined chromatic color. Here, the predetermined chromatic color may be yellow, cyan, or magenta. The exposing unit 210 forms the third latent image so that the third latent image transferred onto the surface of the transfer belt 310 exists in a central area. Here, the central area indicates the area of the transferred second latent image.

It is preferable that the exposing unit 210 irradiates light on the photoconductive drums 320 so that the toner images transferred to the transfer belt 310 are deployed in an order of a toner image of a latent image formed on the photoconductive drum 320 corresponding to black (hereinafter, a toner image of a black latent image), a toner image of a latent image formed on the photoconductive drum 320 corresponding to magenta (hereinafter, a toner image of a magenta latent image), a toner image of a latent image formed on the photoconductive drum 320 corresponding to cyan (hereinafter, a toner image of a cyan latent image), and a toner image of a latent image formed on the photoconductive drum 320 corresponding to yellow (hereinafter, a toner image of a yellow latent image).

The developing unit 220 develops latent images of predetermined images formed on the photoconductive drums 320. Here, the latent images formed on the photoconductive drums 320 may be the latent images of the target images or marks 316.

The developing unit 220 includes a plurality of developing devices, preferably one device for each color unit. Hereinafter, the exposing unit 210 may indicate a set of exposing devices or one exposing device. Similarly, the developing unit 220 may indicate a set of developing devices or one developing device.

As described above, the photoconductive drums 320 exist for respective color units, and the developing unit 220 is located underneath each of the photoconductive drums 320.

Since the photoconductive drums 320 and the developing unit 220 exist for color units, latent images of the target images and marks 316 developed on the photoconductive drums 320 are developed according to the color units. That is, each latent image of the target images and marks 316 is preferably developed as yellow, cyan, magenta, or black.

The transfer belt 310 is moved by rotation of the driving roller 315, and the toner images are transferred to the transfer belt 310. A transferred area among the surface of the transfer belt 310 is called an image area 312, and the remaining area of the surface of the transfer belt is called a non-image area 313. The toner images of the marks 316 are preferably transferred to the non-image area 313.

Upon irradiating light for forming the target images, the exposing unit 210 irradiates the light Dy first and Dk last. Here, the latent images formed by the exposing unit 210 on the photoconductive drums 320 for the respective colors are developed by the developing unit 220 and soon superimposed on the transfer belt 310.

Only when the color registration is performed well, the target images formed on the photoconductive drums 320 match to allow a user to obtain a precise printed image. The developed latent images superimposed on the surface of the transfer belt 310 are printed by being pressed on a sheet of paper.

The exposing unit 210 irradiates light for forming the marks 316. The developing unit 220 develops each of the first and third latent images at a predetermined density, according to the color corresponding to the photoconductive drum 320 on which that latent image is formed. Hereinafter, a first toner image indicates a developed first latent image, a second toner image indicates a developed second latent image, and a third toner image indicates a developed third latent image.

The first latent image can be developed with yellow, magenta, or cyan. Here, it is preferable that the shape of the first latent image is the same for the three colors (yellow, magenta, and cyan). It is assumed that the first latent image is bar-shaped for the three colors. It is also preferable that the second latent image is developed with black, and the second latent image is a predetermined shape surrounding the bar shape. The shape of the second latent image is the predetermined shape without the bar shape.

A third toner image should be located in a transferred second toner image when being transferred to the transfer belt 310. Here, the third toner image should be located in an area that includes the area not formed as a toner image within the second toner image. That is, a transferred third toner image should be located in an area that includes the empty portion of the second latent image. In this case, the empty portion has a bar shape.

Hereinafter, it is assumed that the toner images transferred to the transfer belt 310 are deployed in the order of black, magenta, cyan, and yellow. In this case, each toner image has a predetermined area on the transfer belt 310, and these respective areas are called mark areas.

The magenta latent image, cyan latent image, and yellow latent image correspond to the first latent image. The black latent image corresponds to the second and third latent images. That is, the magenta latent image, cyan latent image and yellow latent image is developed with only its own color, such as, the cyan latent image is developed with cyan. However, the black latent image is developed with black and a predetermined chromatic color (magenta, cyan, or yellow).

The color registration compensation apparatus includes the mark sensing unit 230 and color registration controller 240 for the color registration compensation.

The mark sensing unit 230 senses the toner images of the marks 316 formed by the exposing unit 210 for a predetermined time. The predetermined time is preferably longer than the time required for passing all the marks 316 formed on the surface of the transfer belt 310 through the mark sensing unit 230. It is preferable that the mark sensing unit 230 includes a predetermined mark sensor.

In more detail, the mark sensing unit 230 senses the first through third toner images by irradiating predetermined light on the surface of the transfer belt 310 to which the first through third toner images are transferred, and sensing irregularly reflected light among the irradiated light. Here, the predetermined light indicates light having predetermined light intensity.

The mark sensing unit 230 can sense the toner images of the marks 316 by comparing the intensity of the predetermined light with the intensity of the irregularly reflected light. The mark sensing unit 230 also senses the light intensity according to the elapsed time. Here, the light intensity which is sensed is sensing light intensity, which is a function of time.

The mark sensing unit 230 transmits information on the sensing light intensity to the color registration controller 240. Since the sensing light intensity is a function of time, the mark sensing unit 230 transmits time information related to the timings of the first toner image, second toner image and third toner image sensed to the color registration controller 240. Accordingly, the mark sensing unit 230 transmits to the color registration controller 240 the time information related to the times at which the first toner image, second toner, image and third toner image are sensed.

Since the mark sensing unit 230 senses the irregularly reflected light among the irradiated predetermined light, defects on the transfer belt 310, such as cracks, have little effect on the sensing and are not confused with toner images. That is, it is preferable that the mark sensing unit 230 does not sense regularly reflected light among the irradiated predetermined light.

The color registration controller 240 calculates exposure starting times for the respective color units using the time information transmitted from the mark sensing unit 230, and transmits the calculated exposure starting times to the exposing unit 210. The exposing unit 210 then begins the exposure at the calculated exposure starting times for the respective color units, and forms the target images on the respective photoconductive drums 320.

The latent images of the target images formed on the photoconductive drums 320 are transferred to the surface of the transfer belt 310 by passing through a developing process and transfer process. The transferred toner images are output to the printing medium 314. As a result, the exposing unit 210 irradiates light onto the photoconductive drums 320 to form target images on the photoconductive drums 320, only if the color registration controller 240 transmits the calculated exposure starting times to the exposing unit 210.

In FIG. 2, the reference character OUT1 indicates a target image developed by the developing unit 220. It is preferable that OUT1 is a set of target images for respective colors.

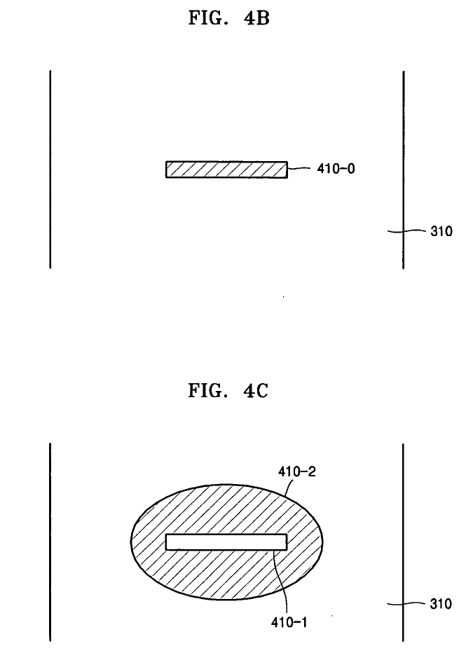

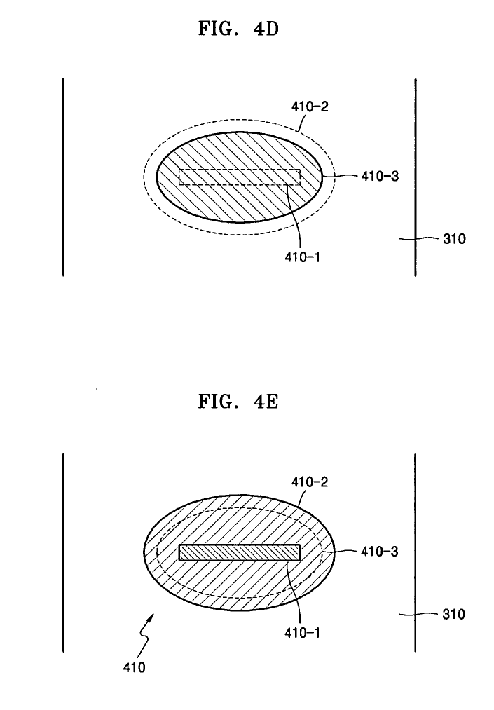

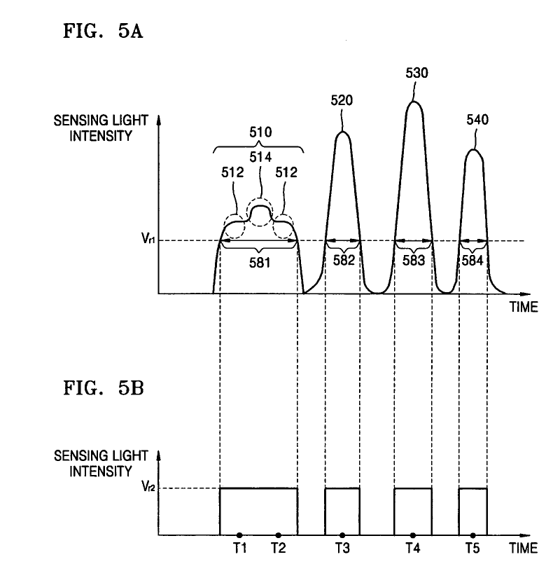

FIGS. 4A through 4E are reference diagrams for illustrating a toner image of a black mark transferred to the surface of the transfer belt 310. FIGS. 5A and 5B are timing diagrams illustrating light intensity sensed by the color registration compensation apparatus in the electrophotographic printer according to an exemplary embodiment of the present invention.

FIG. 4A is an example of the first through third toner images transferred to the transfer belt 310. As described above, it is assumed that the transferred mark areas are deployed in the order of black, magenta, cyan, and yellow. That is the reference numerals 410, 411, 420, and 421 are toner images of black latent images; reference numerals 412, 413, 422, and 423 are toner images of magenta latent images; reference numerals 414, 415, 424, and 425 are toner images of cyan latent images; and reference numerals 416, 417, 426, and 427 are toner images of yellow latent images.

Referring to FIG. 4A, toner images of marks 401 and 402 are transferred over two lines (hereinafter, a registration pattern). Here, the toner images of the marks 401 and 402 indicate images obtained by developing latent images of the marks 401 and 402.

The exposing unit 210 irradiates light on the photoconductive drums 320 so that two registration patterns are formed. One registration pattern includes two black latent images, two magenta latent images, two cyan latent images, and two yellow latent images, in order for the color registration controller 240 to calculate color registration compensation values, that is, the exposure starting times.

The mark sensing unit 230 senses a mark area in the order of the reference numerals 410, 412, 414, 416, 420, 422, 424, and 426. Similarly, the mark sensing unit 230 senses a mark area in the order of the reference numerals 411, 413, 415, 417, 421, 423, 425, and 427.

The reference numerals 412, 413, 414, 415, 416, 417, 422, 423, 424, 425, 426, and 427 are the first toner image. The reference numerals 410, 411, 420, and 421 are a combination of the second toner image and third toner image.

Referring to FIGS. 4B through 4E, the toner images of the black latent image 410, 411, 420, and 421 (hereinafter, black toner images) consist of an appropriate combination of the second toner image and the third toner image. The reference numeral 410 will now be described.

Similarly to the magenta latent image, cyan latent image and yellow latent image, the black latent image is developed as the reference numeral 410-0, if the black latent image is developed with its color. Since there is insufficient light intensity to be sensed by the mark sensing unit 230, the color registration controller 240 may overlook the black toner image 410 and calculate an incorrect exposure starting time.

Therefore, to form the black latent image, the exposing unit 210 forms a second toner image 410-2 having a predetermined shape in a surrounding area of a mark 410-1, by irradiating light onto the photoconductive drum 320 corresponding to black. In FIG. 4C, the predetermined shape is oval. In addition, the exposing unit 210 forms a third toner image 410-3 by irradiating light onto the photoconductive drum 320 corresponding to a predetermined chromatic color. Here, the third toner image 410-3 includes the central area 410-1 within the outline of the transferred second toner image 410-2, as shown in FIG. 4D. To do this, it is preferable that the exposing unit 210 irradiates light onto the photoconductive drum 320 so that a toner image of the predetermined chromatic color can be transferred to the area of the reference numeral 410-3.

As a result, the black toner image 410 and the predetermined chromatic color, as shown in FIG. 4E, consists of black. Here, it is preferable that the predetermined chromatic color is magenta, cyan, or yellow.

If the mark area of the black toner image 410 is described as black, the mark 410-1 of the mark area is a predetermined chromatic color, and the surrounding area 410-2 of the mark area is black.

The surrounding area of the mark area of the black toner image 410 includes not only the reference numeral 410-2, but also the reference numeral 410-3. In the surrounding area 410-2 and 410-3, an area of black mixed with a predetermined chromatic color coexists. Since the predetermined chromatic color is covered by black when it is sensed by the mark sensing unit 230, it is preferable that the surrounding area 410-2 of the mark 410-1 is not sensed.

Since the mark 410-1 has a chromatic color in the mark area of the black toner image 410, the light intensity reflected from the mark area of the black toner image 410 can be considerably increased. Accordingly, the possibility of the mark sensing unit 230 overlooking the black toner image 410 is reduced.

However, if the density of black developed in the surrounding area 410-2 is low, or the density of the chromatic color developed in the surrounding area 410-3 is high, the chromatic color covered by black can be sensed by the mark sensing unit 230.

Referring to FIG. 5A, the reference numeral 510, a time width for the same sensing light intensity, is greater than the reference numerals 520 through 540. That is, a time width 581 of a black toner image 510 is greater than a time width 582 of a toner image of a magenta latent image (hereinafter, a magenta toner image) 520, time width 583 of a toner image of a cyan latent image (hereinafter, a cyan toner image) 530, or time width 584 of a toner image of a yellow latent image (hereinafter, a yellow toner image) 540. It is preferable that the values of the reference numerals 582, 583 and 584 are all the same.

If the chromatic color 410-3 covered by black 410-2 is not sensed by the mark sensing unit 230, the timing diagram of sensing light intensity of light reflected from the black toner image 510 does not have portions such as the reference numeral 512. In this case, the value of the reference numeral 581 is equal to the reference numeral 582, 583, or 584.

The color registration controller 240 can transform the timing diagram of sensing light intensity received from the mark sensing unit 230 to a timing diagram of a pulse wave by setting the sensing light intensity, having a value equal to or greater than a certain threshold value, to a predetermined value, and setting the other sensing light intensity to 0. In FIGS. 5A and 5B, the threshold value is Vr1 and the predetermined value is Vr2.

The color registration controller 240 receives the sensing light intensity and time information shown in FIG. 5A from the mark sensing unit 230, generates the pulse wave shown in FIG. 5B, and obtains time information from the pulse wave.

The units of an exposure starting time calculated by the color registration controller 240 may be seconds, micro-seconds, or any other unit without limitation. The color registration controller 240 can calculate a finer exposure starting time with smaller units. It is preferable that a unit, in which only one time information can be included in a time width (one of the numeral references 581 through 584), is used.

According to FIG. 5B, the color registration controller 240 obtains five points of time information (T1, T2, T3, T4, and T5) from the pulse wave. Since the color registration controller 240 calculates the exposure starting time using T1, T2, T3, and T4, a correct exposure starting time cannot be calculated.

That is, since the time width 581 of the black toner image 510 cannot correctly provide the time information of black, the color registration controller 240 cannot calculate the correct exposure starting time using the results shown in FIGS. 5A and 5B.

Accordingly, the apparatus suggests the color registration controller 240, which does not generate this problem.

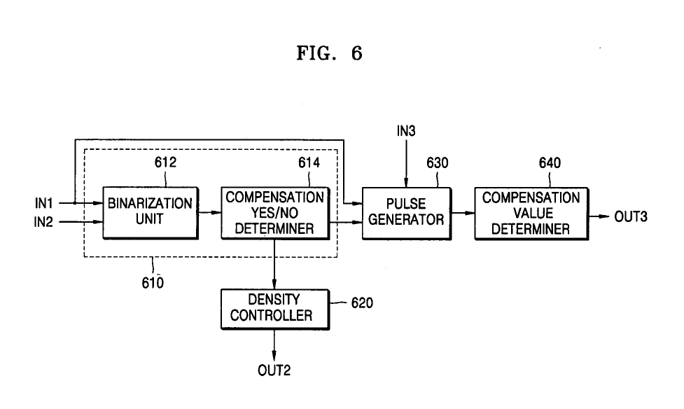

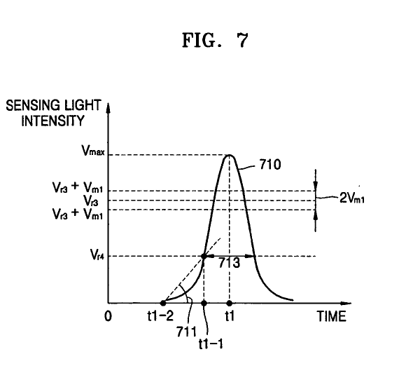

The operation of the color registration controller 240 will now be described in more detail with reference to FIGS. 6 through 8. However, when the exposing unit 210 irradiates light for forming target images, neither the mark sensing unit 230 nor the color registration controller 240 operate.

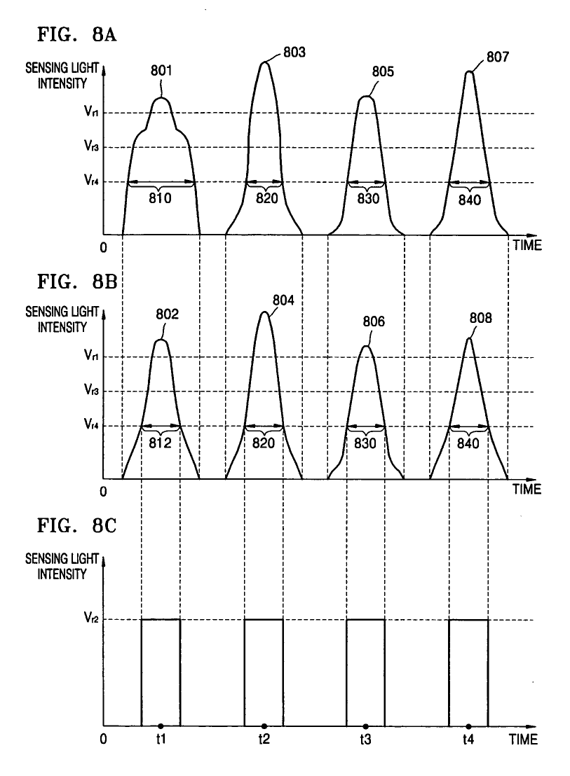

FIG. 6 is a detailed block diagram of the color registration controller 240 shown in FIG. 2. FIGS. 7, 8A, 8B, and 8C are timing diagrams of sensing light intensity for illustrating IN1 and IN2 shown in FIG. 6.

Referring to FIGS. 6 through 8, the color registration controller 240 includes a compensation yes/no decision unit 610, a density controller 620, a pulse generator 630, and a compensation value determiner 640.

The reference character IN1 indicates sensing light intensity information and time information received from the mark sensing unit 230. The compensation yes/no decision unit 610 determines whether to determine exposure starting times using IN1. That is, the compensation yes/no decision unit 610 determines whether to transmit IN1 to the compensation value determiner 640.

If the compensation yes/no decision unit 610 determines a compensation disapproval, the compensation value determiner 640 of the color registration controller 240 does not calculate a color registration compensation value.

If the compensation yes/no decision unit 610 determines a compensation approval, the compensation value determiner 640 calculates the color registration compensation value and adjusts the exposure starting times of the exposing unit 210 based on the calculated compensation value. Thus, a mis-registration is compensated.

The compensation yes/no decision unit 610 compares values of the sensing light intensity IN1 with the time of a predetermined threshold and determines whether to transmit the time information IN1 to the compensation value determiner 640. In more detail, the compensation yes/no decision unit 610 compares the maximum value of the sensing light intensity IN1 to a predetermined reference light intensity value, compares a sensing time 713, 810, 812, 820, 830, or 840 required for the sensing of mark areas to a predetermined reference time, and determines whether to transmit the time information IN1 to the compensation value determiner 640.

If the maximum value of the sensing light intensity IN1 is greater than the predetermined reference light intensity value, and if the sensing time 713, 810, 812, 820, 830, or 840 is less than the predetermined reference time, the compensation yes/no decision unit 610 transmits the time information IN1 to the compensation value determiner 640.

The reference character IN2 indicates the predetermined threshold compared to the values of the sensing light intensity IN1. That is, IN2 may be the reference light intensity value or the reference time. In FIG. 7, the threshold indicates the reference light intensity value Vr3, and in FIG. 8A, the threshold indicates the reference time. It is preferable that the reference light intensity value and the reference time are previously determined and can be changed during the operation of the compensation yes/no decision unit 610.

Hereinafter, a condition of the sensing light intensity when the compensation yes/no decision unit 610 determines the compensation approval is called a compensation possible condition.

In order to satisfy the compensation possible condition, it is preferable that the maximum value of the sensing light intensity IN1, that is, the maximum sensing light intensity value, is greater than Vr3. However, considering an error generated in a real measurement, “the maximum sensing light intensity value is greater than Vr3” can be substituted with “the maximum sensing light intensity value is greater than Vr3+Vm1 or Vr3+Vm1.

Also, in order to satisfy the compensation possible condition, it is preferable that the sensing time 713, 810, 812, 820, 830, or 840 is less than the predetermined reference time. The sensing time 713, 810, 812, 820, 830, or 840 indicates the difference between times having a predetermined sensing light intensity value Vr4 calculated for each mark area (one of the reference numerals 710 and 801 through 808). The mark area may be a mark area of a black toner image 801 or 802, mark area of a magenta toner image 803 or 804, mark area of a cyan toner image 805 or 806, or mark area of a yellow toner image 807 or 808. It is preferable that Vr4 is previously determined and can be changed during the operation of the color registration controller 240. Here, the value of Vr4 is not limited. However, it is preferable that the value of Vr4 is determined on the following basis. It is preferable that the value of Vr4 is set so that only one time information from each of the magenta toner image, cyan toner image, and yellow toner image, sensed when the sensing light intensity having a value less than Vr4 among the entire sensing light intensity, is set to 0, and when sensing light intensity, having a value equal to or greater than Vr4, is set to a certain value. It is also preferable that the reference time is set so that only one time information from each of the magenta toner image, cyan toner image, and yellow toner image is sensed. To do this, it is preferable that Vr4 is equal to Vr1. Alternatively, Vr4 can be set to a minimum value among sensing light intensity values located at an outer predetermined angle 711, based on a time axis in the timing diagram of the sensing light intensity. In FIG. 7, Vr4 is a light intensity value sensed at the time t1-1.

A binarization unit 612 compares values of the sensing light intensity IN1 with the time of the predetermined threshold IN2 and transmits the comparison results to a compensation yes/no determiner 614, which determines whether to transmit information on the sensing light intensity IN1 to the compensation value determiner 640. Accordingly, the compensation yes/no decision unit 610 determines whether a color registration compensation value is calculated using the sensing light intensity IN1 currently given.

If the compensation yes/no decision unit 610 determines a compensation disapproval, it commands the density controller 620 to operate. For example, if the maximum value of the sensing light intensity IN1 is less than the reference light intensity value Vr3, the compensation yes/no determiner 614 commands the density controller 620 to increase and re-sense a developing density. The developing density is the density of a developer for developing latent images. Here, it is preferable that the developer is a toner.

Similarly, if the sensing time is greater than the reference time, the compensation yes/no determiner 614 commands the density controller 620 to change and re-sense the developing density.

The density controller 620 receives an operational command from the compensation yes/no determiner 614 and generates a signal OUT2 for commanding the exposing unit 210, developing unit 220, and mark sensing unit 230 to operate. The exposing unit 210 reforms latent images of the marks 316 on the photoconductive drums 320 in response to the signal OUT2. The developing unit 220 develops the reformed latent images. For example, the developing unit 220 develops a reformed second latent image with a higher density than before or a reformed third latent image with a lower density than before. Here, if the developing unit 220 cannot develop the reformed latent images with changed density, the developing unit 220 can indicate that “a density control failed” through a user interface (not shown). The mark sensing unit 230 senses the developed latent images, that is, toner images. Then, the mark sensing unit 230 transmits information on newly generated sensing light intensity IN1 to the color registration controller 240.

The compensation yes/no decision unit 610 generally determines a compensation disapproval when the maximum sensing light intensity of a chromatic toner image is less than the reference light intensity Vr3 or when the sensing time 810 or 812 of the black toner image 801 or 802 is greater than the reference time. Here, the chromatic toner image is the magenta, cyan, or yellow toner image. In FIG. 8A, the sensing time 810 of the black toner image 801 is greater than the reference time, and the compensation yes/no decision unit 610 thus determines the compensation disapproval. Here, it is preferable that the reference time is set to be less than the sensing time 820, 830, or 840 of the chromatic toner image.

In this case, the density controller 620 commands the exposing unit 210 to reform the first through third latent images, the developing unit 220 to redevelop the reformed first through third latent images, and the mark sensing unit 230 to re-sense the redeveloped first through third latent images. FIG. 8B is a timing diagram of the re-sensed sensing light intensity IN1. If the re-sensed sensing time 812 of the black toner image 802 is less than the reference time, the compensation yes/no decision unit 610 determines a compensation approval.

However, if the compensation yes/no decision unit 610 determines the compensation disapproval again, regardless of the operation of the density controller 620, the compensation yes/no decision unit 610 determines the compensation disapproval and counts the number of accumulated compensation disapprovals. If the number of accumulated compensation disapprovals is less than a threshold number of determinations, the compensation yes/no decision unit 610, commands the density controller 620 to re-operate.

If the number of accumulated compensation disapprovals is equal to the threshold number of determinations, the compensation yes/no decision unit 610 can command the compensation value determiner 640 to determine a color registration compensation value. In this case, the compensation value determiner 640 determines the exposure starting times using the information on the sensing light intensity IN1 transmitted to the compensation yes/no decision unit 610 when the number of accumulated compensation disapprovals is equal to the threshold number of determinations. Here, the threshold number of determinations can be freely determined by the user.

Alternatively, the compensation yes/no decision unit 610 can prevent in advance the exposure starting times from being compensated with wrong information by commanding the compensation value determiner 640 to not determine the color registration compensation value.

If the compensation yes/no decision unit 610 determines the compensation approval, the compensation yes/no decision unit 610 transmits the sensing light intensity IN1 and time information (hereinafter, sensing information) to the compensation value determiner 640. Here, the color registration controller 240 can include the pulse generator 630. In this case, the compensation value determiner 640 receives the sensing information from the pulse generator 630.

The pulse generator 630 transforms a waveform of the sensing light intensity IN1 shown in FIG. 8B to a pulse wave shown in FIG. 8C, and transmits the sensing information extracted from the pulse wave to the compensation value determiner 640. The pulse generator 630 generates the pulse wave by setting sensing light intensity values less than Vr1 to 0, and those equal to or greater than Vr1 to Vr2. The values Vr1, Vr2, and Vr4 may or may not be all equal. Here, IN3 indicates Vr1.

The compensation value determiner 640 calculates the exposure starting times using the time information received from the compensation yes/no decision unit 610 or the pulse generator 630. In FIG. 8C, the time information indicates the time at which the black toner image is sensed is t1, the magenta toner image is sensed is t2, the cyan toner image is sensed is t3, and the yellow toner image is sensed is t4.

It is preferable that the compensation value determiner 640 considers not only the time information but also the rotational velocities of the photoconductive drums 320, the rotational velocity of the driving roller 315, and the positions at which the marks begin to be exposed on the surfaces of the photoconductive drums 320, when calculating the exposure starting times.

The reference character OUT3 indicates each of the calculated exposure starting times.

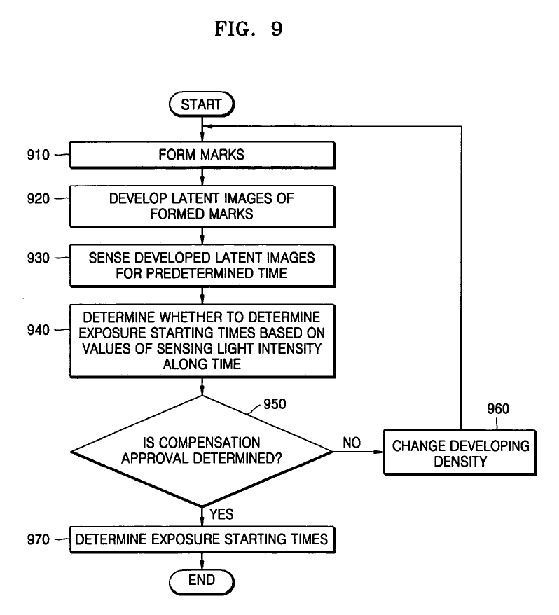

FIG. 9 is a flowchart illustrating a color registration compensation method in an electrophotographic printer according to an exemplary embodiment of the present invention. Referring to FIG. 9, the color registration compensation method includes: sensing transferred toner images (operations 910 through 930); determining whether to determine exposure starting times (operations 940 and 950); and operating according to the determination results (operations 960 and 970).

The exposing unit 210 forms latent images of the marks 316 in operation 910, and the developing unit 220 generates toner images by developing the formed latent images in operation 920. The mark sensing unit 230 senses the toner images in operation 930, and the compensation yes/no decision unit 610 determines whether to determine exposure starting times based on values of sensing light intensity which is a function of time in operation 940.

If the compensation yes/no decision unit 610 determines a compensation disapproval in operation 950, the density controller 620 changes developing density in operation 960 and commands the exposing unit 210, developing unit 220, and mark sensing unit 230 to re-operate.

If the compensation yes/no decision unit 610 determines a compensation approval in operation 950, the compensation value determiner 640 determines the exposure starting times using time information in operation 970.

The embodiments of the present invention can be written as computer programs and can be implemented in general-use digital computers that execute the programs using a computer-readable recording medium. Examples of the computer-readable recording medium include magnetic storage media, such as, ROM, floppy disks, hard disks, and the like; optical recording media, such as, CD-ROMs, DVDs, and the like; and storage media such as carrier waves, that is, transmission through the internet. The computer-readable recording medium can also be distributed over network coupled computer systems so that the computer-readable code is stored and executed in a distributed fashion. The functional programs, codes and code segments for embodying the exemplary embodiments of present invention may be easily deducted by programmers in the art which the present invention belongs to.

As described above, according to a color registration compensation apparatus, method in an electrophotographic printer, and a computer-readable recording medium storing computer program according to exemplary embodiments of the present invention, a color registration compensation value can be correctly calculated by detecting the case where a mark area corresponding to a color unit is inappropriately developed and sensed as a mark area corresponding to another color unit.

While the invention has been shown and described with reference to certain exemplary embodiments thereof, it will be understood by those of ordinary skill in the art that various changes in form and details may be made therein without departing from the spirit and scope of the invention as defined by the appended claims.

What is claimed is:

1. A color registration compensation apparatus for adjusting exposure starting times on photoconductive drums for respective color units so that images developed with a plurality of color tones match each other on a transfer belt and are correctly superimposed in an electrophotographic printer, the apparatus comprising:
an exposing unit for forming a first latent image, which is a latent image of a mark, by irradiating light onto the photoconductive drum corresponding to a chromatic color, forms a second latent image, having a predetermined shape, on an area surrounding the mark by irradiating light onto the photoconductive drum corresponding to an achromatic color, and forms a third latent image by irradiating light onto the photoconductive drum corresponding to a predetermined chromatic color;
a developing unit for developing the first, second and third latent images with a predetermined density according to color tones corresponding to the photoconductive drums on which the latent images are formed;
a mark sensing unit for sensing toner images by irradiating a predetermined light onto the surface of the transfer belt in which the toner images are transferred after developing the latent images, and by sensing irregularly reflected light of the irradiated light; and
a color registration controller for comparing a time-based value of sensing light intensity, which is intensity of the irregularly reflected light sensed for the mark area, with a predetermined threshold and determining the exposure starting times according to time information relating to a point of time of latent image sensing in response to a comparison result,
wherein the toner images are the developed latent images, and the toner image of the transferred third latent image exists in an area comprising a central area of the mark surrounding area within the toner image of the transferred second latent image.

2. The apparatus of claim 1, wherein the color registration controller compares a maximum value of the sensing light intensity with a predetermined reference light intensity value, compares a sensing time, which is time required for sensing the mark area, with a predetermined reference time, and adjusts the exposure starting times based on the time information.

3. The apparatus of claim 1, wherein the color registration controller determines the exposure starting times based on the time information, if a maximum value of the sensing light intensity is greater than a predetermined reference light intensity value and if a sensing time, which is time required for sensing the mark area, is less than a predetermined reference time.

4. The apparatus of claim 1, wherein the color registration controller increases a predetermined density and commands re-sensing if a maximum value of the sensing light intensity is less than a predetermined reference light intensity value.

5. The apparatus of claim 1, wherein the color registration controller changes a predetermined density and commands re-sensing if a sensing time, which is time required for sensing each mark area, is greater than a predetermined reference time.

6. The apparatus of claim 5, wherein the developing unit, which receives the re-sensing command, develops the reformed second latent image with a higher density than the predetermined density.

7. The apparatus of claim 5, wherein the developing unit, which receives the re-sensing command, develops a reformed third latent image with a lower density than the predetermined density.

8. The apparatus of claim 1, wherein the color registration controller comprises:
a compensation yes/no decision unit for determining whether a maximum value of the sensing light intensity is greater than a predetermined reference light intensity value, and whether a sensing time, which is time required for sensing each mark area, is less than a predetermined reference time; and
a compensation value determiner for determining the exposure starting time for a respective color units using sensed time information, if the maximum value of the sensing light intensity is greater than the predetermined reference light intensity value and if the sensing time is less than the predetermined reference time.

9. The apparatus of claim 8, wherein the color registration controller further comprises a pulse generator which sets sensing light intensity values less than a previously determined value to 0 and sets sensing light intensity values exceeding the previously determined value to a predetermined value, if the maximum value of the sensing light intensity is greater than the predetermined reference light intensity value and if the sensing time is less than the predetermined reference time,
wherein the compensation value determiner determines the exposure starting time for the respective color units using the time information obtained by sensing the predetermined value, and
the sensing light intensity value is a value of the sensing light intensity.

10. The apparatus of claim 9, wherein the color registration controller further comprises a density controller which commands the exposing unit, developing unit, and mark sensing unit to operate under circumstances that the predetermined density is changed, if the maximum value of the sensing light intensity is less than the reference light intensity value.

11. The apparatus of claim 9, wherein the color registration controller further comprises a density controller which commands the exposing unit, developing unit, and mark sensing unit to operate under circumstances that the predetermined density is changed, if the sensing time is greater than the reference time.

12. The apparatus of claim 2, wherein the predetermined threshold, predetermined reference light intensity value, and predetermined reference time are variable.

13. A color registration compensation method of adjusting exposure starting times on photoconductive drums for respective color units so that images developed with a plurality of color tones match each other on a transfer belt and are correctly superimposed in an electrophotographic printer, the method comprising the steps of:
forming a first latent image, which is a latent image of a mark, by irradiating light onto the photoconductive drum corresponding to a chromatic color, forming a second latent image, having a predetermined shape, on an area surrounding the mark by irradiating light onto the photoconductive drum corresponding to an achromatic color, and forming a third latent image by irradiating light onto the photoconductive drum corresponding to a predetermined chromatic color;
developing the first, second, and third latent images with a predetermined density according to color tones corresponding to the photoconductive drums on which the latent images are formed;
sensing toner images by irradiating a predetermined light onto the surface of the transfer belt in which the toner images are transferred after developing the latent images, and by sensing irregularly reflected light of the irradiated light; and
comparing a time-based value of sensing light intensity, which is the intensity of the irregularly reflected light sensed for the mark area, with a predetermined threshold, and determining exposure starting times according to time information relating to a point of time of latent image sensing in response to a comparison result,
wherein the toner images are the developed latent images, and the toner image of the transferred third latent image exists in an area comprising a central area of the mark surrounding area within the toner image of the transferred second latent image.

14. The method of claim 13, wherein the step of comparing a time-based value of the sensing light intensity comprises:
determining as a determination result whether a maximum value of the sensing light intensity is greater than a predetermined reference light intensity value and whether a sensing time, which is time required for the sensing for the mark area, is less than a predetermined reference time; and
determining as a determination result the exposure starting time for respective color units using sensed time information if the maximum value of the sensing light intensity is greater than the reference light intensity value and if the sensing time is less than the reference time.

15. The method of claim 14, wherein the step of comparing a time-based value of the sensing light intensity further comprises the step of:
proceeding to the method of forming a first latent image under circumstances that the predetermined density is changed, if the maximum value of the sensing light intensity is less than the predetermined reference light intensity value.

16. The method of claim 15, wherein the step of proceeding to forming a first latent image comprises:
calculating a total number of determinations, if the maximum value of the sensing light intensity is less than the predetermined reference light intensity value; and
determining the exposure starting time for the respective color units using the sensed time information of the time corresponding to a threshold number of determinations determined in advance, if the total number of determinations is equal to the threshold number of determinations.

17. The method of claim 14, wherein the step of comparing a time-based value of the sensing light intensity further comprises:
proceeding to the step of forming a first latent image when the predetermined density is changed, if the sensing time is greater than the reference time.

18. The method of claim 17, wherein the step of proceeding to the step of comparing a time-based value of the sensing light intensity comprises:
calculating a total number of determinations, if the sensing time is greater than the reference time; and
stopping the determination of the exposure starting times, if the total number of determinations is equal to a threshold number of determinations determined in advance.

19. A computer-readable recording medium storing a computer readable program for performing a color registration compensation method of adjusting exposure starting times on photoconductive drums for respective color units so that images developed with a plurality of color tones match each other on a transfer belt and are correctly superimposed in an electrophotographic printer, the method comprising:
forming a first latent image, which is a latent image of a mark, by irradiating light onto the photoconductive drum corresponding to a chromatic color, forming a second latent image, having a predetermined shape, on an area surrounding the mark by irradiating light onto the photoconductive drum corresponding to an achromatic color, and forming a third latent image by irradiating light onto the photoconductive drum corresponding to a predetermined chromatic color;
developing the first, second and third latent images with a predetermined density according to color tones corresponding to the photoconductive drums on which the latent images are formed;
sensing toner images by irradiating a predetermined light onto the surface of the transfer belt in which the toner images are transferred after developing the latent images, and by sensing irregularly reflected light of the irradiated light; and
comparing a time-based value of sensing light intensity, which is the intensity of the irregularly reflected light sensed for the mark area, with a predetermined threshold, and determining the exposure starting times according to time information relating to a point of time of latent image sensing in response to a comparison result,
wherein the toner images are the developed latent images, and the toner image of the transferred third latent image exists in an area comprising a central area of the mark surrounding area within the toner image of the transferred second latent image.
